(19) United States
(12) Patent Application Publication
(10) Pub. No.: US 2016/0065467 A1
(43) Pub. Date: Mar. 3, 2016

(54) Configurable Signaling Field and its Indication

(71) Applicant: MEDIATEK INC., Hsinchu (TW)

(72) Inventors: Tianyu Wu, Fremont, CA (US); Jianhan Liu, San Jose, CA (US); Thomas Edward Pare, JR., Mountain View, CA (US)

(21) Appl. No.: 14/837,296

(22) Filed: Aug. 27, 2015

Related U.S. Application Data
(60) Provisional application No. 62/043,540, filed on Aug. 29, 2014.

(51) Int. Cl. H04L 12/741; H04L 29/06

(52) U.S. Cl. CPC H04L 45/74; H04L 65/60; H04W 84/12

(57) ABSTRACT

A method of providing a configurable signaling (SIG) field is proposed to reduce the SIG overhead of a data packet in a wireless network. The SIG field comprises both HE-SIG-A field and HE-SIG-A2 field. HE-SIG-A field contains only necessary information for a default network scenario (e.g., indoor non-OFDMA SU-MIMO) to avoid HE-SIG-A2. HE-SIG-A2 field contains OFDMA, MU-MIMO, and/or outdoor parameter settings. By using HE-SIG-A to indicate the existence, mode, and/or length of HE-SIG-A2, the signaling overhead for default scenario can be reduced by avoiding the entire HE-SIG-A2 field. The number of symbols required for HE-SIG-A2 is adjustable based on each transmission scenario and indicated by HE-SIG-A. Further, because higher MCS such as QPSK may be supported for HE-SIG-A2, additional signaling overhead is reduced.

### CROSS REFERENCE TO RELATED APPLICATIONS

This application claims priority under 35 U.S.C. §119 from U.S. Provisional Application No. 62/043,540, entitled “Configurable SIG field and its Indication,” filed on Aug. 29, 2014, the subject matter of which is incorporated herein by reference.

### TECHNICAL FIELD

The disclosed embodiments relate generally to wireless network communications, and, more particularly, to configurable signaling field and its indication in wireless communications systems.

### BACKGROUND

IEEE 802.11 is a set of media access control (MAC) and physical layer (PHY) specification for implementing wireless local area network (WLAN) communication in the Wi-Fi (2.4, 3.6, 5, and 60 GHz) frequency bands. The 802.11 family consists of a series of half-duplex over-the air modulation techniques that use the same basic protocol. The standards and amendments provide the basis for wireless network products using the Wi-Fi frequency bands. For example, IEEE 802.11n is an amendment that improves upon the previous IEEE 802.11 standards by adding multiple-input multiple-output antennas (MIMO). IEEE 802.11ac is an amendment to IEEE 802.11 that builds on 802.11n. Changes compared to 802.11n include wider channels (80 or 160 MHz versus 40 MHz) in the 5 GHz hand, more spatial streams (up to eight versus four), higher-order modulation (up to 256-QAM vs. 64-QAM), and the addition of Multi-user MIMO (MU-MIMO). IEEE 802.11ad is an amendment that defines a new physical layer for 802.11 networks to operate in the 60 GHz millimeter wave spectrum. This frequency band has significantly different propagation characteristics than the 2.4 GHz and 5 GHz bands where Wi-Fi networks operate. IEEE 802.11ah defines a WLAN system operating at sub 1 GHz license-exempt bands. 802.11ah can provide improved transmission range compared with the conventional 802.11 WLANs operating in the 2.4 GHz and 5 GHz bands. 802.11ah can be used for various purposes including large-scale sensor networks, extended range hotspot, and outdoor Wi-Fi for cellular traffic offloading, whereas the available bandwidth is relatively narrow. IEEE 802.11ax is the successor to 802.11ac; it will increase the efficiency of WLAN networks. IEEE 802.11ax is currently at a very early stage of development and has the goal of providing 4× the throughput of 802.11ac.

In wireless communications systems, wireless devices communicate with each other through various well-defined frame structures. Exchanged bit streams in the physical layer are arranged temporally into sequences called frames. Frames are in turn divided into very specific and standardized sections. For example, the current IEEE 802.11 standards have defined various frame types for use in transmission of data as well as management and control of wireless links.

In general, a frame comprises sequentially of a PLCP PPDU, a frame header, and a payload. The PLCP PPDU further comprises a preamble, a PPDU header, and a PPDU payload. The PPDU header has one or more signaling fields. Conventionally, a signaling field carries information pertinent to the operation of the physical layer. To decode a frame, the receiver uses the information in the signaling field to determine how to decode the remainder of the frame.

In IEEE 802.11ax, more information needs to be indicated in the signaling fields. For example, new promising technologies such as OFDMA and UL MU-MIMO etc. might be supported. When OFDMA is supported, the resource allocation need to be indicated. In another example, new outdoor scenario will be supported. More indicators for Indoor/Outdoor scenario, CP length, Doppler (Travelling Pilot support) etc. may be indicated. In yet another example, new OFDM/OFDMA symbol format might be supported. As a result, 1×, 4× and even 8× symbol length need to be indicated.

For each of the different cases, different information needs to be indicated. For OFDMA packets and outdoor environment, the singling field will be longer to indicate the extra information. For default scenarios such as SU OFDM packet in indoor environment, the signaling field will be shorter. A solution is sought to reduce the singling field overhead for different types of packets and different environment.

### SUMMARY

A method of providing a configurable signaling (SIG) field is proposed to reduce the SIG overhead of a data packet in a wireless network. The SIG field comprises both HE-SIG-A field and HE-SIG-A2 field. HE-SIG-A field contains only necessary information for a default network scenario (e.g., indoor non-OFDMA SU-MIMO) to avoid HE-SIG-A2. On the other hand, HE-SIG-A2 field includes OFDMA parameters, MU-MIMO parameter, and/or outdoor parameter settings. By using HE-SIG-A to indicate the existence, mode, and/or length of HE-SIG-A2, the signaling overhead for default scenario can be reduced by avoiding the entire HE-SIG-A2 field. The number of symbols required for HE-SIG-A2 is adjustable based on each transmission scenario and indicated by HE-SIG-A. Further, because higher MCS such as QPSK may be supported for HE-SIG-A2, additional signaling overhead is reduced.

In one embodiment, a source wireless station (STA) determines a data packet mode of a data packet to be transmitted to a destination station in a wireless communications network. The source STA encodes the data packet based on the data packet mode. The data packet mode indicates at least one of an OFDM packet, an OFDMA packet, a SU-MIMO packet, a MU-MIMO packet, an indoor packet, and an outdoor packet, and each mode is associated with a transmission scenario. The data packet comprises multiple signaling (SIG) fields before multiple training fields and a data payload after the multiple training fields. A first SIG field indicates information of a subsequent second SIG field. In one example, the first SIG field indicates a number of symbols in the second SIG field. In another example, the first SIG field indicates the data packet mode, and each mode is associated with a predefined parameter set carried by the second SIG field. In yet another example, the first SIG field indicates a modulation and coding scheme (MCS) to be applied for the second SIG field. Finally, the source STA transmits the data packet to the destination STA in the wireless communications network.

In another embodiment, a destination station (STA) receives a data packet transmitted from a source STA in a wireless communications network. The destination STA decodes the data packet. The data packet comprises multiple signaling (SIG) fields before multiple training fields and a data payload after the multiple training fields. A first SIG field indicates information of a subsequent second SIG field. In one example, the first SIG field indicates a number of symbols in the second SIG field. In another example, the first SIG field indicates the data packet mode, and each mode is associated with a predefined parameter set carried by the second SIG field. In yet another example, the first SIG field indicates a modulation and coding scheme (MCS) to be applied for the second SIG field. The destination STA determines a data packet mode and corresponding parameters associated with a transmission mode based on the SIG fields. The data packet mode indicates at least one of an OFDM packet, an OFDMA packet, a SU-MIMO packet, a MU-MIMO packet, an indoor packet, and an outdoor packet.

Other embodiments and advantages are described in the detailed description below. This summary does not purport to define the invention. The invention is defined by the claims.

### BRIEF DESCRIPTION OF THE DRAWINGS

FIG. 1 illustrates a wireless communications system and a data packet with configurable signaling field in accordance with one novel aspect.

FIG. 2 is a simplified block diagram of a wireless transmitting device and a receiving device in accordance with a novel aspect.

FIG. 3 illustrates of using HE-SIG-A indication for HE-SIG-A2 modes and MCS.

FIG. 4 illustrates one embodiment of HE-SIG-A design based on VHT-SIG-A.

FIG. 5 illustrates another embodiment of HE-SIG-A design for SU-MIMO and MU-MIMO cases.

FIG. 6 illustrates one embodiment of HE-SIG-A2 design in IEEE 802.11ax network.

FIG. 7 is flow chart of a method of encoding and transmitting a data packet with configurable SIG field and indication in accordance with a novel aspect.

FIG. 8 is a flow chart of a method of receiving and decoding a data packet with configurable SIG field and indication in accordance with a novel aspect.

### DETAILED DESCRIPTION

Reference will now be made in detail to some embodiments of the invention, examples of which are illustrated in the accompanying drawings.

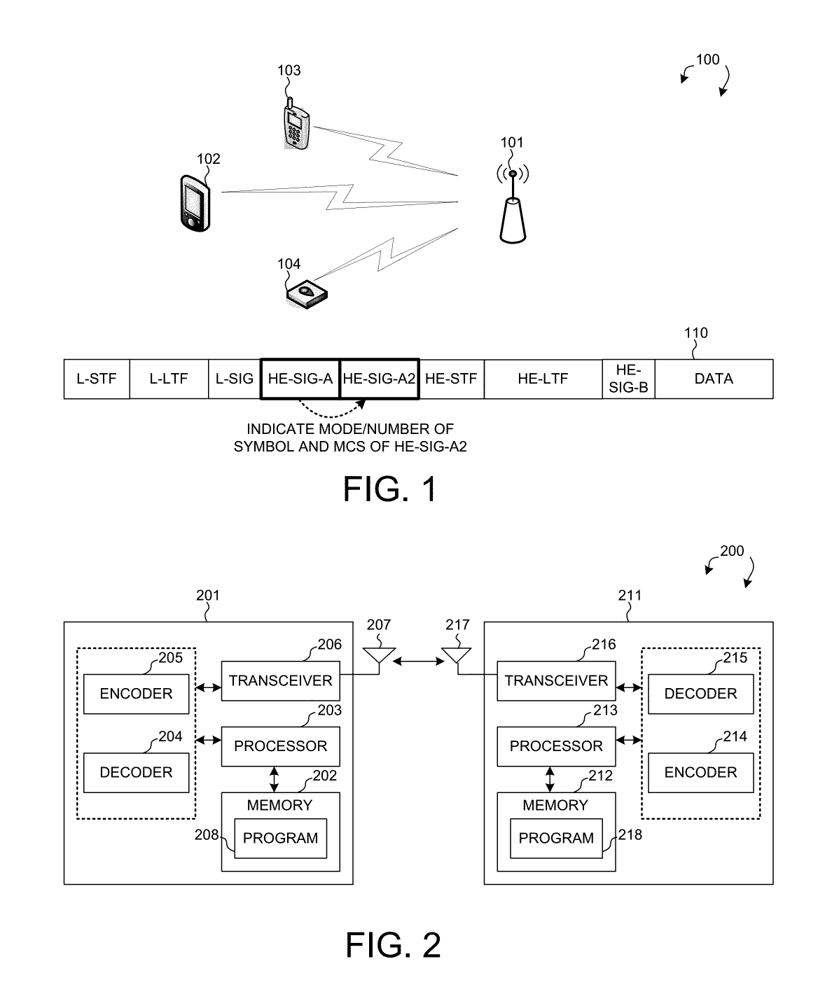

FIG. 1 illustrates a wireless communications system and a data packet with configurable signaling field in a wireless communications system 100 in accordance with one novel aspect. Wireless communications system 100 comprises a wireless access point AP 101, and a plurality of wireless access stations 102-104. In wireless communications system 100, the wireless devices communicate with each other through various well-defined packet preamble structures. The source AP 101 transmits an OFDM/OFDMA physical layer convergence procedure (PLCP) protocol data unit (PPDU) packet 110 in WLAN 100. The destination station receives PPDU packet 110 and tries to decode PPDU packet 110.

In an IEEE 802.11ax network, PPDU packet 110 comprises legacy short training field (L-SFT), legacy long training field (L-LTF), legacy SIG field (L-SIG), HE-SIG-A field, HE-STF field, HE-LTF field, HE-SIG-B field, and data field. Within the legacy preamble, the legacy SIG field L-SIG is included. In the L-SIG field, the length field is included. The length can be used to calculate the packet duration. Since the L-SIG field includes only one-bit parity check, HT-SIG, VHT-SIG, and HE-SIG field needs to be decoded. In IEEE 802.11ax, more information needs to be indicated in the signaling fields. For example, new promising technologies such as OFDMA and uplink MU-MIMO etc. might be supported. When OFDMA is supported, resource allocation need to be indicated. In another example, new outdoor scenario will be supported. More indicators for Indoor/Outdoor scenario, CP length, Doppler (Travelling Pilot support) etc. may be indicated. In yet another example, new OFDM/OFDMA symbol format might be supported. As a result, 1×, 4× and even 8× symbol length need to be indicated. In the example of FIG. 1, STA 211, 102 may apply MU-MIMO and outdoor transmission, STA 103 may apply OFDMA and outdoor transmission, and STA 104 may apply MU (OFDMA+MU-MIMO) and outdoor transmission.

For each of the different network scenarios, different information needs to be indicated in the SIG fields. For OFDMA packets and outdoor environment, the HE-SIG-A field will be longer to indicate the extra information. For default scenarios such as SU OFDM packet in indoor environment, the HE-SIG-A field will be shorter. In one novel aspect, a configurable SIG field is proposed to reduce the SIG overhead. As illustrated in FIG. 1, PPDU packet 110 comprises both HE-SIG-A field and HE-SIG-A2 field. HE-SIG-A field contains only necessary information for a default scenario (e.g., indoor non-OFDMA) to avoid HE-SIG-A2. On the other hand, HE-SIG-A2 field shall include OFDMA parameters, MU-MIMO parameter, and/or outdoor parameter settings.

FIG. 2 is a simplified block diagram of wireless devices 201 and 211 in accordance with a novel aspect. For wireless device 201, antenna 207 transmits and receives radio signals. RF transceiver module 206, coupled with the antenna, receives RF signals from the antenna, converts them to baseband signals and sends them to processor 203. RF transceiver 206 also converts received baseband signals from the processor, converts them to RF signals, and sends out to antenna 207. Processor 203 processes the received baseband signals and invokes different functional modules to perform features in wireless device 201. Memory 202 stores program instructions and data 208 to control the operations of the wireless device.

Similar configuration exists in wireless device 211 where antenna 217 transmits and receives RF signals. RF transceiver module 216, coupled with the antenna, receives RF signals from the antenna, converts them to baseband signals and sends them to processor 213. The RF transceiver 216 also converts received baseband signals from the processor, converts them to RF signals, and sends out to antenna 217. Processor 213 processes the received baseband signals and invokes different functional modules to perform features in wireless device 211. Memory 212 stores program instructions and data 218 to control the operations of the wireless device.

The wireless devices 201 and 211 also include several functional modules to carry out some embodiments of the present invention. Encoder modules 205 and 215 convert original information from one format to another, while decoder modules 204 and 214 reverse the operation of the encoders so that the original information can be retrieved. The different functional modules are circuits can be configured and implemented by software, firmware, hardware, or any combination thereof. The function modules, when executed by the processors 203 and 213 (e.g., via executing program codes 208 and 218), for example, allow device 201 to encode and transmit a bit stream to device 211, and allow device 211 to receive and decode the bit stream accordingly. In one example, at the transmitter side, the encoder inserts SIG fields into a bit stream. The SIG fields carries information and parameter settings associated with a specific network scenario. At the receiver side, the decoder examines the SIG field and retrieves the corresponding parameter settings accordingly for future operation.

FIG. 3 illustrates the use of HE-SIG-A indication for HE-SIG-A2 modes and MCS. The preamble structure for IEEE 802.11ax is depicted by PPDU packet 310. HE-SIG-A field is the mandatory SIG for all cases. HE-SIG-A includes the most important information needed in all cases. In addition, HE-SIG-A may indicate the existence of HE-SIG-A2 field. Alternatively, the existence of HE-SIG-A2 can be indicated by another field in the preamble. HE-SIG-A may indicate the mode of HE-SIG-A2 if multiple modes are supported. Alternatively, HE-SIG-A may indicate the number of OFDM symbols in HE-SIG-A2. HE-SIG-A may also indicate the modulation and coding scheme (MCS) for HE-SIG-A2 if multiple MCS are supported. HE-SIG-A should also include CRC and Tail bits in the last OFDM symbol. On the other hand, HE-SIG-A2 is the optional SIG field for some cases. HE-SIG-A2 may have different modes for different cases. The definition and/or length of HE-SIG-A2 will change based on the mode. Furthermore, HE-SIG-A2 may support higher MCS such as QPSK.

FIG. 3 also illustrates different examples of HE-SIG-A for HE-SIG-A2 indication. In a first example of HE-SIG-A as depicted by 321, M bits is used in HE-SIG-A to indicate the mode of HE-SIG-A2. M=1 bit can be used for on-off switching for HE-SIG-A2. M=2 bits can be used to support three HE-SIG-A2 modes. For example, Mode-0 indicates no HE-SIG-A2, Mode-1 indicates one-symbol HE-SIG-A2 field, and Mode-2 indicates two-symbol HE-SIG-A2 field. For Mode-1, the one OFDM symbol may indicate the outdoor traffic related parameters and MU related parameters for a small number of users. For Mode-2, the two OFDM symbols may indicate the outdoor traffic related parameters and MU related parameters with more users. The different HE-SIG-A2 modes can also be used to indicate the scenarios. For example, Mode-0 indicates no HE-SIG-A2, Mode-1 indicates MU-MIMO and outdoor, Mode-2 indicates OFDMA and outdoor, Mode-3 indicates MU (OFDMA+MU-MIMO) and outdoor, and so on so forth. Furthermore, the HE-SIG-A2 modes can be associated with different predefined parameter sets. The structure of HE-SIG-A2 and the parameter set for each mode are predefined. For example, for Mode-1, HE-SIG-A2 includes group ID, MCS for each STA and CP-length. For Mode-2, HE-SIG-A2 includes resource allocation map and MCS for each STA.

In a second example of HE-SIG-A as depicted by 322, N bits is used in HE-SIG-A to indicate the MCS of HE-SIG-A2. The number N depends on the number of MCSs HE-SIG-A2 can support. N=1 bit might be a good number to support MCS0 and MCS1. In a third example of HE-SIG-A as depicted by 323, M bits is used in HE-SIG-A to indicate the mode of HE-SIG-A2, as well as N bits is used in HE-SIG-A to indicate the MCS of HE-SIG-A2.

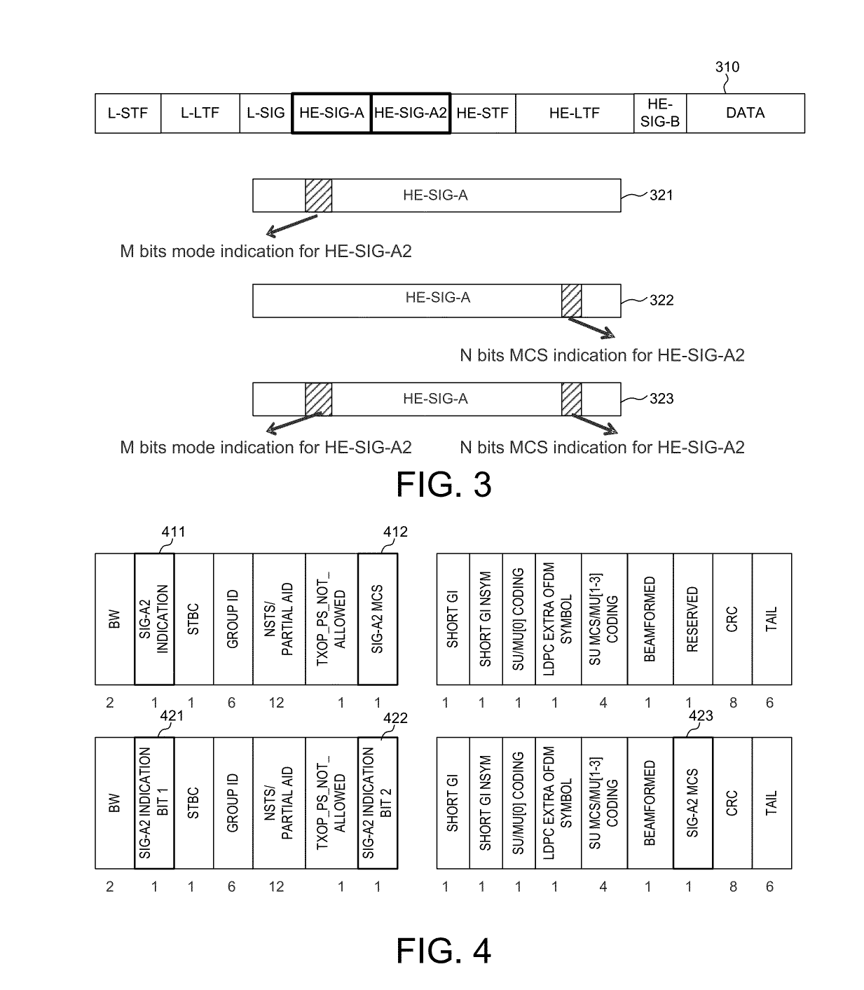

FIG. 4 illustrates one embodiment of HE-SIG-A design based on VHT-SIG-A of IEEE 802.11ac. In general, the HE-SIG-A field includes all information in VHT-SIG-A. The existence of HE-SIG-A2 or mode of HE-SIG-A2 are indicated by one or two reserved bits in VHT-SIG-A. The MCS of HE-SIG-A2 is indicated by one reserved bit in VHT-SIG-A. As depicted by the top diagram of FIG. 4, a first reserved bit 411 is used for HE-SIG-A2 mode indication, and a second reserved bit 412 is used for HE-SIG-A2 MCS indication. As depicted by the bottom diagram of FIG. 4, a first reserved bit 421 is used for HE-SIG-A existence or mode indication, a second reserved bit 422 is used for HE-SIG-A2 mode indication, and a third reserved bit 423 is used for HE-SIG-A2 MCS indication.

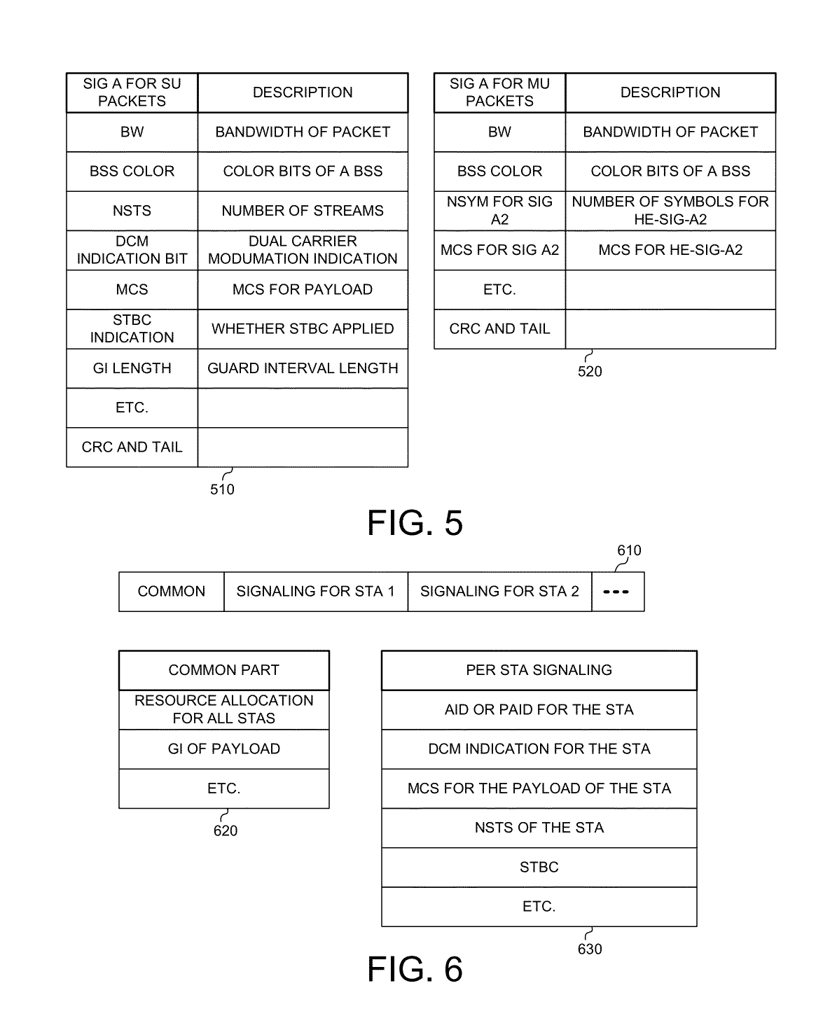

FIG. 5 illustrates one embodiment of HE-SIG-A design for SU-MIMO and MU-MIMO cases in IEEE 802.11ax. In IEEE 802.11ax, the HE-SIG fields can be redefined. To reduce the preamble overhead, the HE-SIG-A is defined to include all the necessary information for a default scenario to avoid HE-SIG-A2. For example, the default scenario for Wi-Fi system could be indoor non-OFDMA SU-MIMO transmissions. There is no HE-SIG-A2 field for the default SU packets. As depicted by table 510, the list of information in the HE-SIG-A field for a SU-MIMO packet should include BW indicating the bandwidth of the packet, BSS color indicating color bits of a BSS, N_{STS} indicating the number of streams, DCM indication indicating dual carrier modulation, MCS for the payload, STBC indication, guard internal length, CRC, and tail bits.

On the other hand, for outdoor, OFDMA, and/or MU-MIMO transmissions, additional parameters need to be indicated by HE-SIG-A2. As depicted by table 520, the list of information in the HE-SIG-A field for a MU-MIMO packet should include BW indicating the bandwidth of the packet, BSS color indicating color bits of a BSS, N_{SYM} indicating the number of symbols for HE-SIG-A2 field, MCS for HE-SIG-A2 field, CRC, and tail bits.

FIG. 6 illustrates one embodiment of HE-SIG-A2 design in IEEE 802.11ax network. For OFDMA and MU-MIMO cases, HE-SIG-A2 should include resource allocation for all the STAB and per STA signaling. As depicted by table 610, each HE-SIG-A2 field comprises a common field and signaling for each STA. As depicted by table 620, the common field comprises resource allocation for all STAB, guard interval length of payload, etc. As depicted by table 630, per-STA signaling comprises AID or partial AID for the STA, DCM indication for the STA, MCS for the payload of the STA, N_{STS} number of streams of the STA, STBC indication, etc. Because the HE-SIG-A2 field may including signaling for more than ten STAB, the length of HE-SIG-A2 field can be quite long. By using HE-SIG-A to indicate the existence, mode, and/or length of HE-SIG-A2, the signaling overhead for default scenario can be reduced by avoiding the entire HE-SIG-A2 field. The number of symbols required for HE-SIG-A2 is adjustable based on each transmission scenario and indicated by HE-SIG-A. Further, because higher MCS such as QPSK may be supported for HE-SIG-A2, additional signaling overhead is reduced.

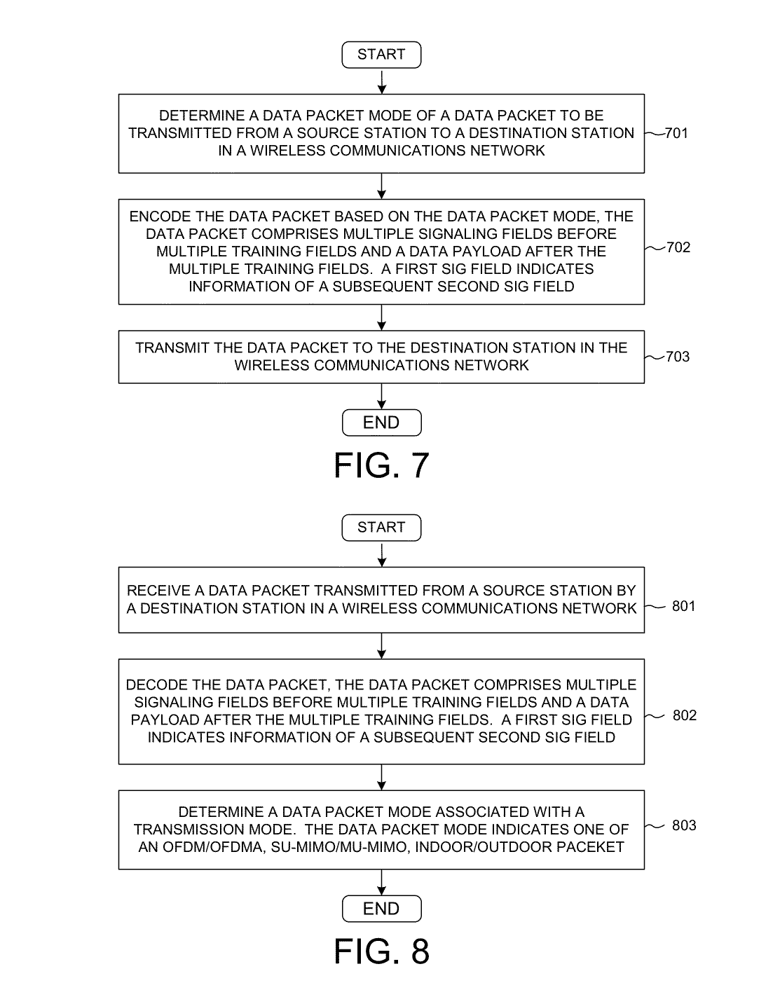

FIG. 7 is flow chart of a method of encoding and transmitting a data packet with configurable SIG field and indication in accordance with a novel aspect. In step 701, a source wireless station (STA) determines a data packet mode of a data packet to be transmitted to a destination station in a wireless communications network. In step 702, the source STA encodes the data packet based on the data packet mode. The data packet mode indicates at least one of an OFDM packet, an OFDMA packet, a SU-MIMO packet, a MU-MIMO packet, an indoor packet, and an outdoor packet, and each mode is associated with a transmission scenario. The data packet comprises multiple signaling (SIG) fields before multiple training fields and a data payload after the multiple training fields. A first SIG field indicates information of a subsequent second SIG field. In one example, the first SIG field indicates a number of symbols in the second SIG field. In another example, the first SIG field indicates the data packet mode, and each mode is associated with a predefined parameter set carried by the second SIG field. In yet another example, the first SIG field indicates a modulation and coding scheme (MCS) to be applied for the second SIG field. In step 703, the source STA transmits the data packet to the destination STA in the wireless communications network.

FIG. 8 is a flow chart of a method of receiving and decoding a data packet with configurable SIG field and indication in accordance with a novel aspect. In step 801, a destination station (STA) receives a data packet transmitted from a source STA in a wireless communications network. In step 802, the destination STA decodes the data packet. The data packet comprises multiple signaling (SIG) fields before multiple training fields and a data payload after the multiple training fields. A first SIG field indicates information of a subsequent second SIG field. In one example, the first SIG field indicates a number of symbols in the second SIG field. In another example, the first SIG field indicates the data packet mode, and each mode is associated with a predefined parameter set carried by the second SIG field. In yet another example, the first SIG field indicates a modulation and coding scheme (MCS) to be applied for the second SIG field. In step 803, the destination STA determines a data packet mode and corresponding parameters associated with a transmission mode based on the SIG fields. The data packet mode indicates at least one of an OFDM packet, an OFDMA packet, a SU-MIMO packet, a MU-MIMO packet, an indoor packet, and an outdoor packet.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
determining a data packet mode of a data packet to be transmitted from a source station to a destination station in a wireless communications network;
encoding the data packet based on the data packet mode, wherein the data packet comprises multiple signaling (SIG) fields before multiple training fields and a data payload after the multiple training fields, and wherein a first SIG field indicates information of a subsequent second SIG field; and
transmitting the data packet to the destination station in the wireless communications network.

2. The method of claim 1, wherein the data packet mode indicates at least one of an OFDM packet, an OFDMA packet, a SU-MIMO packet, a MU-MIMO packet, an indoor packet, and an outdoor packet, wherein each mode is associated with a transmission scenario.

3. The method of claim 1, wherein the first SIG field comprises all necessary information corresponds to a default network transmission scenario.

4. The method of claim 1, wherein the first SIG field indicates a number of symbols in the second SIG field.

5. The method of claim 1, wherein the first SIG field indicates the data packet mode, and wherein each mode is associated with a predefined parameter set carried by the second SIG field.

6. The method of claim 1, wherein the first SIG field indicates a modulation and coding scheme (MCS) to be applied for the second SIG field.

7. The method of claim 1, wherein the wireless communications network is an IEEE 802.11ax network.

8. A wireless device, comprising:
a processor that determines a data packet mode of a data packet to be transmitted to a destination station in a wireless communications network;
an encoder that encodes the data packet based on the data packet mode, wherein the data packet comprises multiple signaling (SIG) fields before multiple training fields and a data payload after the multiple training fields, and wherein a first SIG field indicates information of a subsequent second SIG field; and
a transmitter that transmits the data packet to the destination station in the wireless communications network.

9. The device of claim 8, wherein the data packet mode indicates at least one of an OFDM packet, an OFDMA packet, a SU-MIMO packet, a MU-MIMO packet, an indoor packet, and an outdoor packet, wherein each mode is associated with a transmission scenario.

10. The device of claim 8, wherein the first SIG field comprises all necessary information corresponds to a default network transmission scenario.

11. The device of claim 8, wherein the first SIG field indicates a number of symbols in the second SIG field.

12. The device of claim 8, wherein the first SIG field indicates the data packet mode, and wherein each mode is associated with a predefined parameter set carried by the second SIG field.

13. The device of claim 8, wherein the first SIG field indicates a modulation and coding scheme (MCS) to be applied for the second SIG field.

14. The device of claim 8, wherein the wireless communications network is an IEEE 802.11ax network.

15. A method comprising:
receiving a data packet transmitted from a source station by a destination station in a wireless communications network;
decoding the data packet, wherein the data packet comprises multiple signaling (SIG) fields before multiple training fields and a data payload after the multiple training fields, and wherein a first SIG field indicates information of a subsequent second SIG field; and
determining a data packet mode and corresponding parameters associated with a transmission scenario based on the first and second SIG fields, wherein the data packet mode indicates at least one of an OFDM packet, an OFDMA packet, a SU-MIMO packet, a MU-MIMO packet, an indoor packet, and an outdoor packet.

16. The method of claim 15, wherein the first SIG field comprises all necessary information corresponds to a default network transmission scenario.

17. The method of claim 15, wherein the first SIG field indicates a number of symbols in the second SIG field.

18. The method of claim 15, wherein the first SIG field indicates the data packet mode, and wherein each mode is associated with a predefined parameter set carried by the second SIG field.

19. The method of claim 15, wherein the first SIG field indicates a modulation and coding scheme (MCS) to be applied for the second SIG field.

20. The method of claim 15, wherein the wireless communications network is an IEEE 802.11ax network.
